(19) United States
(12) Patent Application Publication
(10) Pub. No.: US 2010/0300332 A1
(43) Pub. Date: Dec. 2, 2010

(54) ATTACHMENT DEVICE

(76) Inventor: James Donald Hayman, Western Australia (AU)

Correspondence Address: HARNESS, DICKEY & PIERCE, P.L.C., P.O. BOX 8910, RESTON, VA, 20195, US

(21) Appl. No.: 12/734,319

(22) PCT Filed: Oct. 27, 2008
(86) PCT No.: PCT/AU2008/001588

§ 371 Date: Aug. 12, 2010

(30) Foreign Application Priority Data
Oct. 26, 2007 (AU) 2007905894
Aug. 29, 2008 (AU) 2008904491

(51) Int. Cl. B65D 19/38; F16B 2/20

(52) U.S. Cl. 108/51.11; 24/455

(57) ABSTRACT

An attachment device (10) for attaching a web (79) of wrapping film to a surface, the attachment device (10) comprising a body (13) having at least one wedged bite portion (43) adapted to receive and captively retain the wrapping web (79). A pallet (11) comprising an attachment device (10) for attaching a web (79) of wrapping film to a surface of the pallet (11), the attachment device (10) comprising a body (13) having at least one wedged bite portion (43) adapted to receive and captively retain the wrapping web (79).

### FIELD OF THE INVENTION

This invention relates to an attachment device for releasably attaching wrapping film to a pallet, as well as a pallet incorporating such an attachment device.

### BACKGROUND ART

The use of pallets in factories, warehouses, wholesale and retail businesses for transporting and storing goods is widespread. Pallets provide great advantages for the transportation and storage of goods. Goods loaded on them are not in direct contact with the floor. Also, pallets can be easily moved around with help of forklifts.

It is common to wrap a load of goods on a pallet in wrapping film in order to stabilise and provide protection for the load on the pallet during storage, maneuverings and transport. This is particularly the case when the load comprises a plurality of discrete objects such as packages or containers. Typically, the wrapping film comprises a web of wrapping film (typically in roll form) which is attached at one end to the pallet and then progressively unwound from the roll and wrapped around the pallet and the load thereon. Attachment of the web to the pallet prior to wrapping is typically done by scrunching an end section of a web together and then tying that scrunched end section about part of the pallet, such as for example about a stringer or a decking board of the pallet. This has several disadvantages. One disadvantage is that it is necessary for there to be an exposed part of the pallet about which the scrunched end section of the web can be tied. Further, it can be time consuming to have to thread the scrunched end section of the web through part of the pallet knot the scrunched end together to secure the web to the pallet. There is also often unused surplus material extending from the knot, which contributes to wastage of wrapping film. A still further disadvantage is that the knotted section of the web needs to be removed from the pallet after the pallet has been unloaded. It can be difficult and time consuming to untie the knot and almost invariably the knotted portion of the scrunched end is cut to separate it from the pallet. This requires use of a cutting device, such as a knife, which can present a safety issue for a user. It is against this background, and the problems and difficulties associated therewith, that the present invention has been developed.

### DISCLOSURE OF THE INVENTION

According to a first aspect of the invention there is provided an attachment device for attaching a web of wrapping film to a surface, the attachment device comprising a body having at least one wedged bite portion adapted to receive and captively retain the wrapping web.

In one arrangement, the body comprises a base and a tongue projecting from the base, the tongue and the base defining the at least one wedged bite portion.

The attachment device may further comprise at least one protrusion to deflect the tongue from the base for defining the at least one wedged portion.

Preferably, the tongue has two lateral flanks, each defining a wedged bite portion with respective adjacent portions of the base.

The tongue may be formed integrally with the base or it may be formed separately from the base.

In a further arrangement the body comprises a split portion defining the bite portion.

Preferably, the split portion has a first end and the split portion tapering inwardly from the first end to a second end; the first end being adapted to receive the web.

Preferably, the second end is closed.

In another arrangement, the body comprises at least one tongue, the tongue and the surface defining the at least one bite portion.

In a further arrangement, the body is adapted to be attached to the surface.

Preferably, the body comprises attachment means to fasten the body to the surface.

Preferably, the attachment means comprise mounting holes adapted to receive' fasteners.

Alternatively, the body is releasably attached to the surface.

Preferably, the body comprises at least one resilient portion adapted to secure the attachment device to the surface.

Preferably, the at least one resilient portion comprises at least one tooth for gripping engagement with the pallet.

The body may be configured to be clampingly retained between two spaced apart frame elements, the arrangement being that body is adapted to be jammed or wedged between the two frame elements. In this regard, the body may be adapted to resiliently deflect for insertion between, and engagement with, the two frame elements.

In yet another arrangement, the body is formed integrally with the surface.

Preferably, the body is adapted to provide protection to the wedged bite portion. In an arrangement, the body comprises at least one non-cutting contour.

In a further arrangement, the body comprises at least one indentation.

In another version, the portion adapted to receive and retain the wrapping film is rotatable to face any direction opposite to or away from the resultant of forces applied by the wrapping film under tension thereby further securing and reducing the possibility of accidental dislodgement of the wrapping web from the attachment device.

Preferably, the surface is a surface of a pallet.

According to a second aspect of the invention there is provided a pallet incorporating at least one attachment device as previously described.

In an arrangement, the at least one attachment device is integrally formed in at least one stringer of the pallet.

Alternatively, the pallet comprises at least one surface adapted to receive at least one attachment device.

Preferably, the at least one surface comprises a cavity adapted to receive the attachment device.

Preferably, the at least one attachment device is located between a plurality of deck boards of the pallet.

Alternatively, the at least one attachment device is located at an exterior surface of the pallet.

### BRIEF DESCRIPTION OF THE DRAWINGS

The invention will be better understood by reference to the following description of several specific embodiments thereof as shown in the accompanying drawings in which:

FIG. 1 is a schematic elevational view of an attachment device according to a first embodiment.

FIG. 2 is a cross section illustrating the attachment device of FIG. 1 fitted onto a pallet;

FIG. 3 is a schematic elevational view of an attachment device according to a second embodiment;

FIG. 4 is a schematic elevational view of an attachment device according to a third embodiment;

FIG. 5 is a side elevational view of the attachment device of FIG. 4;

FIG. 6 is a schematic perspective view illustrating the attachment device of the third embodiment fitted onto a pallet;

FIG. 7 is an elevational view of an attachment device according to a fourth embodiment;

FIG. 8 is a side view of the attachment device of FIG. 7;

FIG. 9 is a schematic elevational view of an attachment device according to a fifth embodiment;

FIG. 10 is a side view of the attachment device of FIG. 9;

FIG. 11 is an end view of the attachment device of FIG. 9;

FIG. 12 is a schematic perspective view of an attachment device according to a sixth embodiment;

FIG. 13 is an elevational view of the attachment device of FIG. 12;

FIG. 14 is a schematic view of a pallet incorporating an attachment device according to a seventh embodiment;

FIG. 15 is a schematic perspective view of a pallet incorporating an attachment device according to an eighth embodiment;

FIG. 16 is a schematic view of a pallet and attachment device according to a ninth embodiment;

FIG. 17 is a perspective view illustrating the attachment device according to a tenth embodiment of the invention fitted inside a pallet;

FIG. 18a is a top view of a first arrangement of an attachment device according to the tenth embodiment of the invention;

FIG. 18b is a front view of the first arrangement of an attachment device according to the tenth embodiment of the invention;

FIG. 19a is a top view of a second arrangement of the attachment device according to the tenth embodiment of the invention;

FIG. 19b is a side view of the second arrangement of an attachment device according to the tenth embodiment of the invention;

FIG. 20 is a perspective view illustrating the second arrangement of the attachment device according to the tenth embodiment of the invention fitted inside a pallet;

FIG. 21 is a top view of a third arrangement of the attachment device according to the tenth embodiment of the invention;

FIG. 22 is a top view of a fourth arrangement of the attachment device according to the tenth embodiment of the invention;

FIG. 23 is a top view of a fifth arrangement of the attachment device according to the tenth embodiment of the invention, and

FIG. 24 is a perspective view of the invention with a rotating portion for receiving and retaining the wrapping web.

### BEST MODE(S) FOR CARRYING OUT THE INVENTION

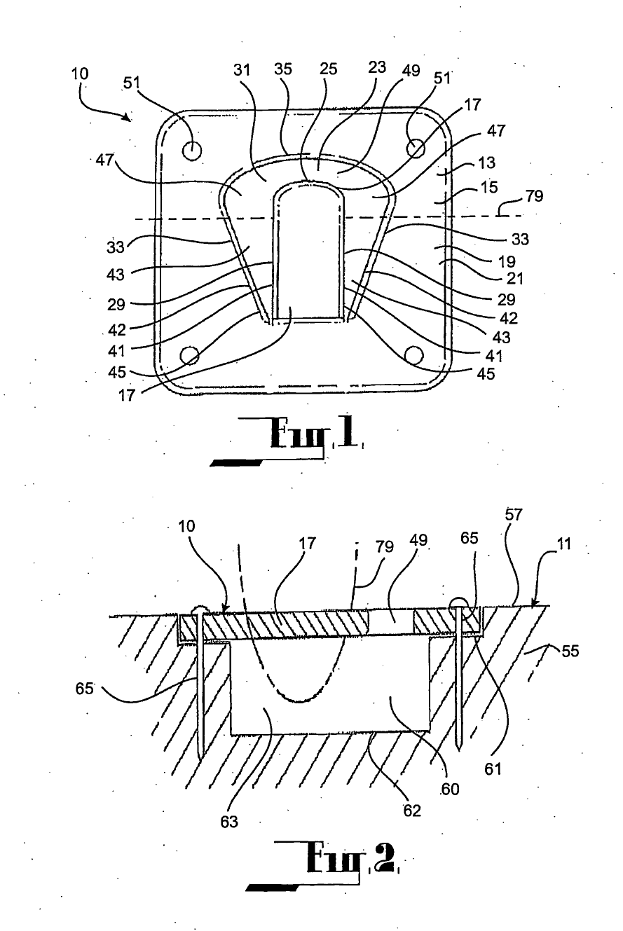

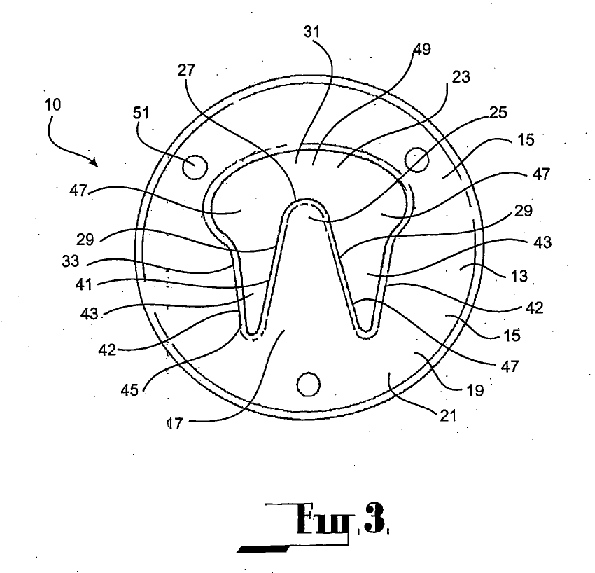

Referring to FIGS. 1 and 2 of the drawings there is shown an attachment device 10 according to a first embodiment for attaching an end section of a web of wrapping film to a pallet 11 (see FIG. 17). In order to facilitate attachment to the attachment device 10, the end section of the web is scrunched together to form an elongate formation, as is conventional practice in the prior art method of attachment involving tying the web to the pallet. The scrunching process involves bringing the longitudinal edges of the web at the end section together, along with the intervening film material therebetween.

As shown in FIG. 1, the attachment device 10 comprises a body 13 having a base 15 and a tongue 17. The body 13 has a hole 23 formed therein configured to define the tongue 17 with respect to the remainder of the body 13 which constitutes the base 15. The tongue 17 has one end 25 formed integrally with the base 15 and the other end 27 at its free end. The tongue 17 also has two lateral flanks 29 extending between the two ends 25, 27.

The hole 23 defines an opening 31 within the base 15. The opening 31 has two edge sections 33 one adjacent each lateral flank 29 of the tongue 17, and a further edge section 35 adjacent the free end 27 of the tongue, as best seen in FIG. 1.

With this arrangement, each lateral flank 29 defines a first jaw 41 and the adjacent edge section 33 of the opening 31 defines a second jaw 42. The two jaws 41, 42 cooperate to define a bite portion 43 therebetween.

The two jaws 41, 42 are configured to converge inwardly to a closed end 45 of the bite portion 43 adjacent the location at which the tongue 17 merges with the base 15. The other end 47 of the bite portion 43 is open.

The open ends 47 of the two bite portions 43 extend into a clearance space 49 defined within the opening 31 between the free end 27 of the tongue 17 and the adjacent edge section 35 of the opening 31. The clearance space 49 provides access to the free end 27 of the tongue 17, thereby allowing the scrunched end section of the web (not shown) to be looped under the tongue.

The base 15 incorporates mounting holes 51 for receiving fasteners (such as screws or nails) for fixing the attachment device 10 to the pallet 11, as will be explained shortly.

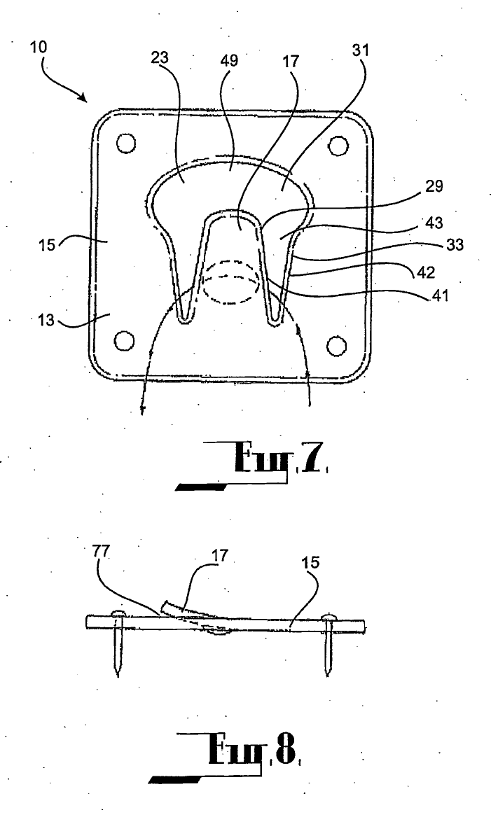

The attachment device 10 according to this embodiment is adapted, to be mounted onto the exterior of the pallet 11 but recessed with respect to an adjacent exterior surface for protection (see FIGS. 2 and 6).

In the arrangement shown in FIG. 2, the attachment device 10 is mounted onto an exterior frame element 55 of the pallet 11 (such as a stringer) having an outer surface 57 (see FIG. 6). Prior to installation of the attachment device 10, an installation hole 60 is formed in the frame element 55 opening onto the outer surface 57. The installation hole 60 comprises an outer section 61 and an inner section 62. The outer section 61 is dimensioned to snugly receive the disk 21 defined by the base 15. The inner section 62 is configured to locate inwardly of the tongue 17, as best seen in FIG. 2. With this arrangement, a cavity 63 is defined adjacent the tongue 17 also as best seen in FIG. 2.

The attachment device is secured to the frame 55 by fasteners 65 (such as screws or nails) extending through the mounting holes 51 into the body of the frame element 55.

Once the attachment device 10 has been installed on the pallet 11, it can be used to anchor an end of a web of wrapping film used to wrap goods loaded on the pallet. In use, an end section of the web of wrapping film is scrunched and looped through the clearance space 49 and under the tongue 17, such that a portion of the scrunch section locates within one bite portion 43, a further portion of the scrunched section locates in the other end bite 43 and an intermediate portion passes under the tongue 17 within cavity 63. The scrunched section is then moved along the tongue 17 so that the two portions thereof are clamped between the tapering jaws 41, 42 which define the bite portions 43.

With this arrangement, the end section of the web of wrapping film can be easily attached to the pallet. Further, the end section of the web of wrapping film can be removed once the pallet has been unloaded simply by a reverse of the procedure.

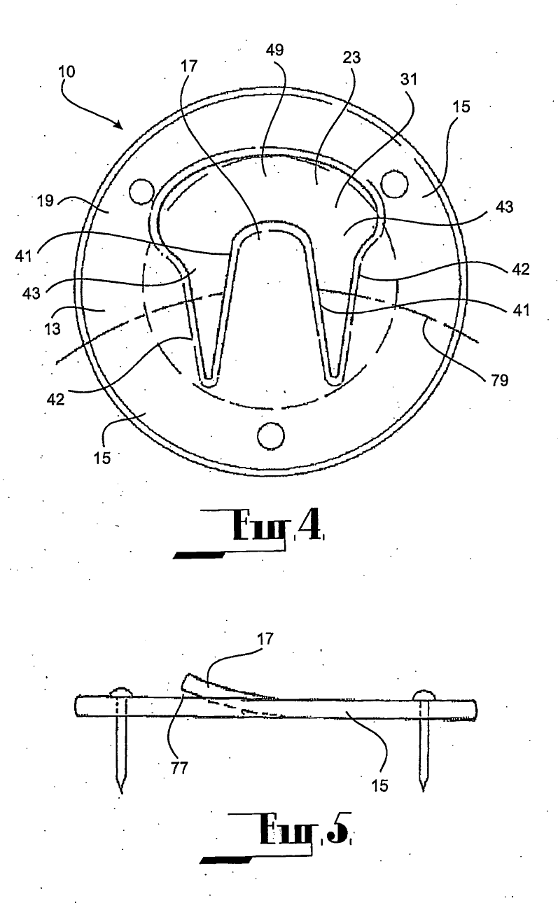

Referring now to FIG. 3, there is shown an attachment device according to a second embodiment. The attachment device according to a second embodiment is similar to the first embodiment and so corresponding reference numerals are used to identify corresponding parts. The attachment device of the second embodiment differs from that of the first embodiment by virtue of the configuration of the hole 23, and more particularly the configuration of the tongue 17.

Referring now to FIGS. 4, 5 and 6 of the drawings, there is shown an attachment device according to a third embodiment. The attachment device according to the third embodiment is similar in some respects to the attachment device according to the first embodiment and corresponding reference numerals are used to identify corresponding parts.

The attachment device according to the third embodiment is adapted for attachment to an internal surface of a pallet 11 (see FIGS. 6, 17 and 20). The attachment device is particularly suitable for a stringer pallet of the type having stringers in spaced apart relationship and decking planks on the upper sides and under sides of the stringers. The spaced relationship between the stringers provides a two-way pallet in which handling forks can be received in the pallet through two opposed sides thereof. Passages for receiving forks extend parallel to the stringers. The attachment device is mounted on the inner face of one of the stringers 71.

In this embodiment, the plate 19 is of generally rectangular configuration and dimensioned to be received snugly against the inner face 73 of the stringer 71 between the upper and lower deck boards (not shown). The plate 19 extends into close proximity to, or in engagement with the upper and lower decking planks so that the pallet handling forks cannot locate against the upper or lower edges of the plate 19 and prise the plate from the pallet or otherwise cause damage to the plate.

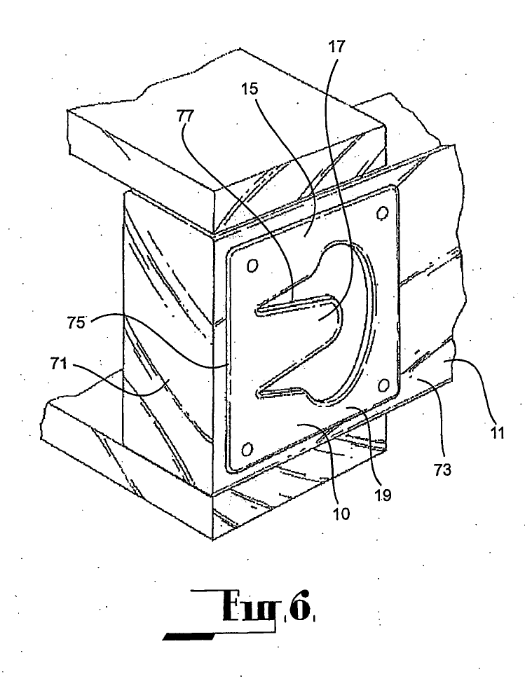

The plate 19 is oriented so that the tongue 17 projects inwardly along the respective passage, as shown in FIG. 6. With this arrangement, the periphery of the base 15 affords protection for the tongue 17 against contact by a pallet handling fork entering the lifting passage of the pallet. The outer edge 75 of the base 15 is profiled (such as by bevelling) to present a ramp for deflecting an approaching pallet handling fork should the latter make contact with the plate 19. As the plate 19 locates snugly against the inner face 73, it is necessary for the tongue 17 to deflect away from the base 15 to provide a space 77 into which the scrunched section (identified by broken lines 79 in FIG. 4) can pass to locate under the tongue 17 and within the two bite portions 43, as shown in FIG. 4 of the drawings. The tongue 17 may be provided with a protrusion (not shown) on the inner side thereof to contact the inner face 73 of the stringer 71 and thereby cause the tongue to deflect outwardly into the condition shown in FIG. 5.

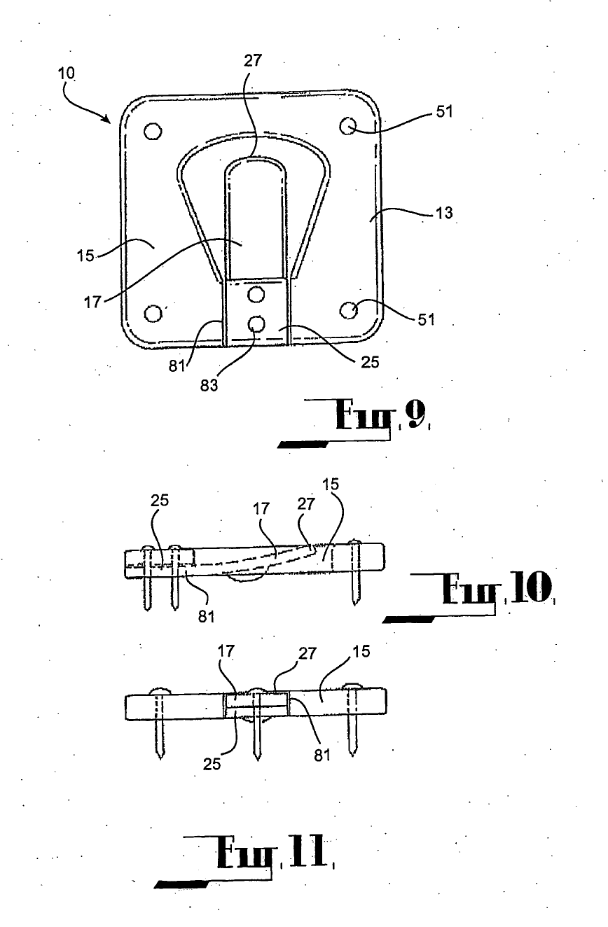

Referring now to FIGS. 7 and 8, there is shown an attachment device according to a fourth embodiment. The attachment device according to the fourth embodiment is similar in many respects to the attachment device according to the third embodiment, apart from the configuration of the opening 23.

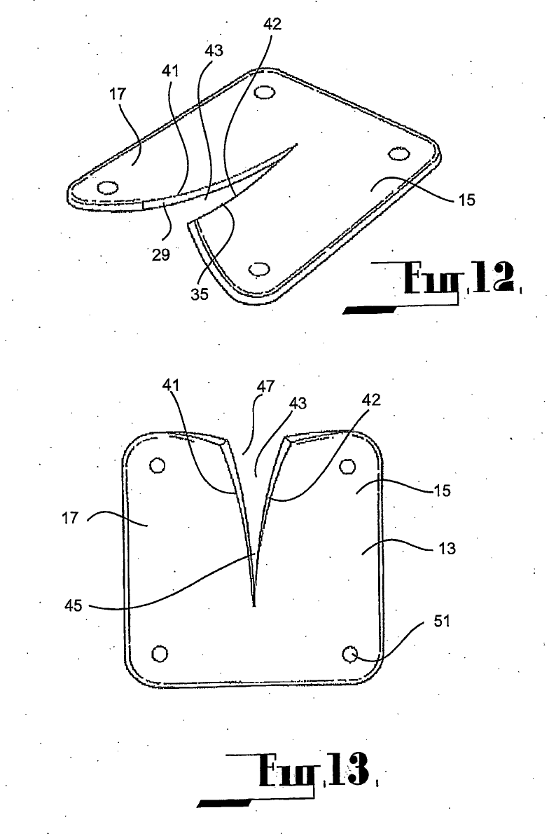

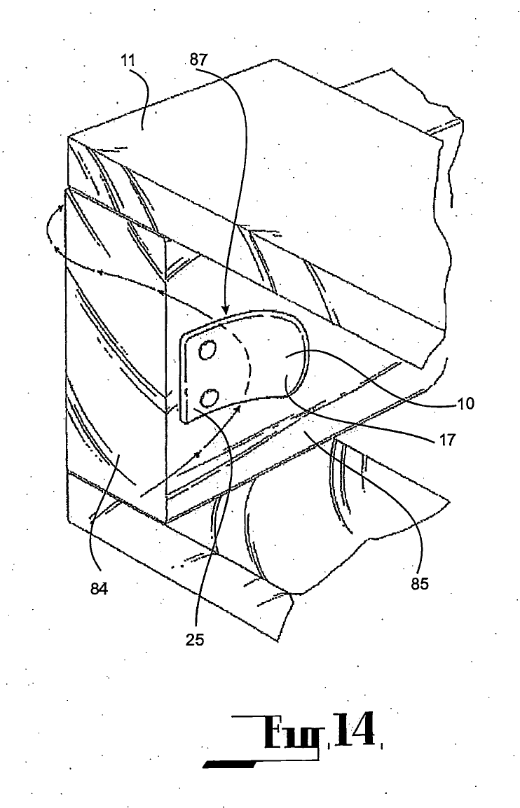

In each of the previous embodiments the attachment device has been of one-piece construction, with the tongue 17 being integral with the base 15. It is, of course, possible for the tongue 17 and the base 15 to be formed separately of each other. Such an arrangement exists in the attachment device according to the fifth embodiment as shown in FIGS. 9, 10 and 11.

In the fifth embodiment, the base 15 incorporates a recess 81 which is adapted to receive the end 25 of the tongue 17. With this arrangement, the tongue 17 is attached to the pallet 11 separately to the base 15. In the arrangement shown the base 15 has mounting holes 51 for attaching it to the pallet. The end section 25 of the tongue 17 also has mounting holes 83 for attaching the tongue 17 to the pallet 11.

The feature of constructing the tongue 17 separately of the base 15 is advantageous in circumstances where the tongue is likely to be damaged. With this arrangement, the tongue 17 can be replaced if damaged, without requiring replacement of the base 15.

In the previous arrangement, each attachment device incorporated a tongue 17 with a bite 43 on each side thereof. Other arrangements with a single bite are possible. One such other arrangement involves body 13 including a wedged split portion with its opening directed in the same direction than the tongue 17 of the previous arrangement so as to allow a scrunched section of a web of wrapping film (not shown) to be clampingly wedged into the split portion.

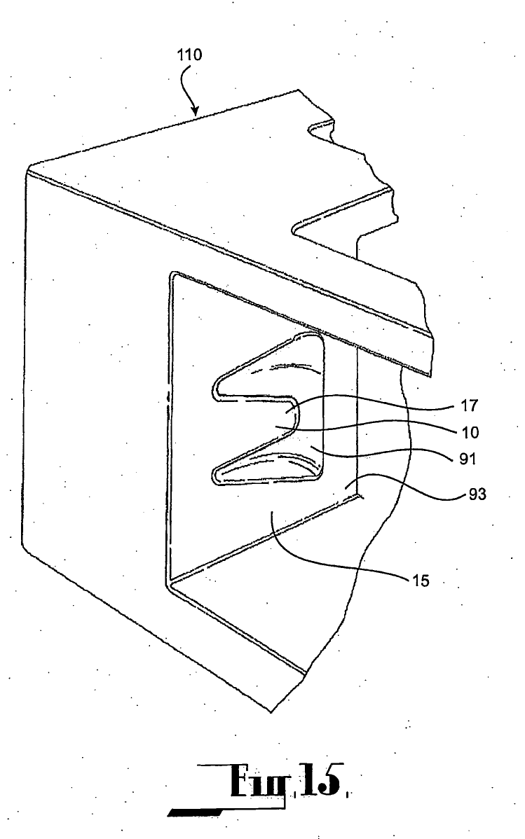

Referring now to FIGS. 12 and 13, there is shown an attachment device according to a sixth embodiment. The attachment device comprises a base 15 and a tongue 17 projecting from the base. The base 15 and the tongue 17 cooperate to form a single bite portion 43, with the bite portion 43 being defined by a flank 29 of the tongue 17 and an adjacent edge 33 of the base.

The tongue 17 is distorted or adapted to deflect to allow a scrunched section of a web of wrapping film to be positioned underneath the tongue so as to pass through the single bite portion 43 such that the scrunched end section can be clampingly wedged into the bite portion.

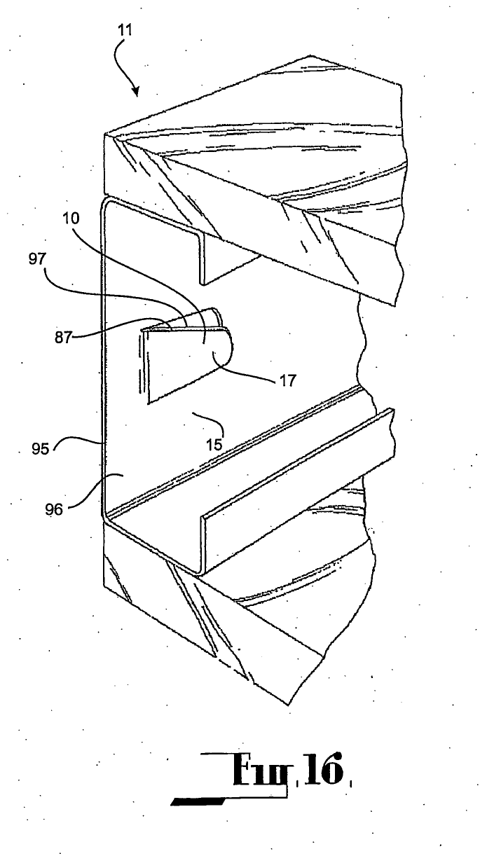

Referring now to FIG. 14 there is shown a pallet 11 incorporating an attachment device according to a seventh embodiment. In this embodiment, the attachment device comprises a tongue 17 of resiliently flexible material such as rubber attached at one end 25 directly to a frame element 84 of the pallet. A suitable type of rubber would be conveyor belt rubber. The tongue 17 forms with the adjacent face 85 of the pallet a wedged space 87 which can receive and clampingly retain the scrunched end of the web.

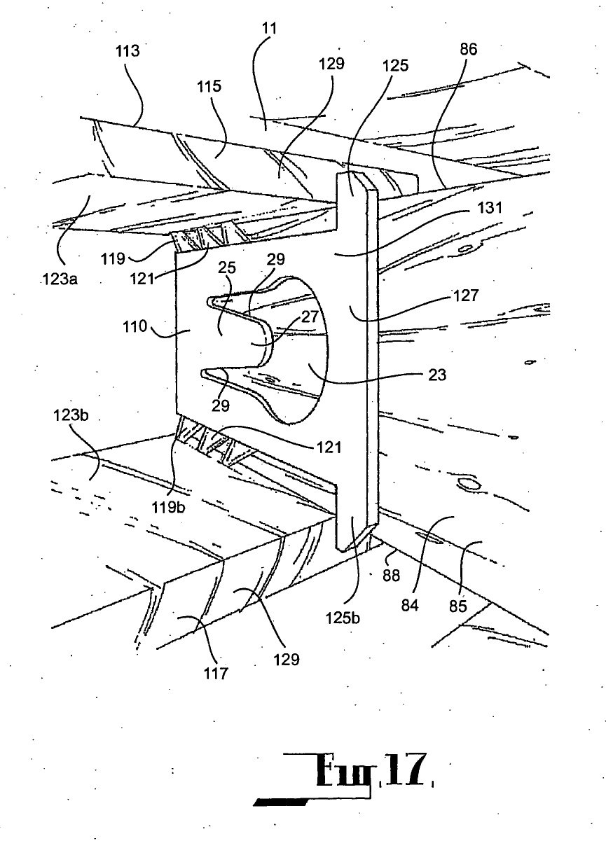

Referring now to FIG. 15, there is shown a pallet incorporating an attachment device 10 according to an eighth embodiment. For sake of simplicity the eighth embodiment is described only with respect to the second embodiment of the invention. However, the eighth embodiment of the invention may be used with respect to any of the attachment devices described with reference to the first to seventh embodiments of the invention. In this embodiment (eighth embodiment), the pallet 11 is formed of plastic material and the attachment device 10 is formed integrally with the pallet 11. Specifically, an opening 91 is formed in a wall 93 of the pallet to define the tongue 17, with the marginal portion of the wall 93 surrounding the opening 91 defining the base 15.

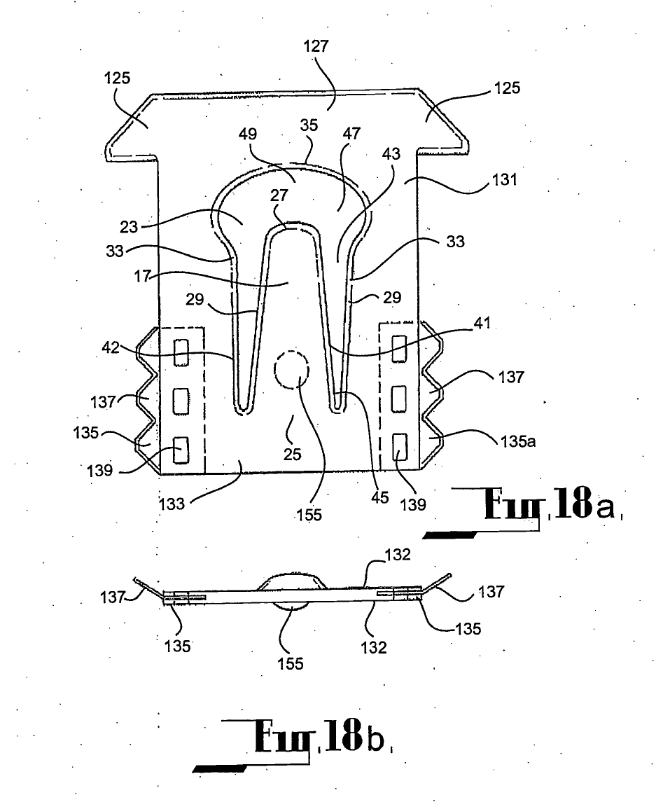

Referring now to FIG. 16 of the drawings, there is shown a pallet 11 incorporating an attachment device 10 according to a ninth embodiment. For sake of simplicity the ninth embodiment is described only with respect to the second embodiment of the invention. However, the ninth embodiment of the invention may be used with respect to any of the attachment devices described with reference to the first to seventh embodiments of the invention. In this embodiment (ninth embodiment) the stringer 84 is formed of metal and the attachment device is incorporated into a frame element 95 of the pallet. The frame element 95 incorporates a wall section 96 in which a cut 97 is formed (such as by punching) to generate the tongue 17. The tongue 17 forms with the wall section 96 a wedged space 87 which can receive and clampingly retain the scrunched end of the web.

All the first to seventh embodiments of the invention are secured to the pallet frame 55 by fasteners 65 which extend through the mounting holes 51 of the attachment device 10 (see FIG. 2). Other arrangements for fixing the attachment device in accordance to the invention to the pallet frame are possible. By way of example, the attachment device may be configured to be clampingly retained between two spaced apart frame elements, the arrangement being that the attachment device is jammed or wedged between the two frame elements. For example, the attachment device may be adapted to resiliently deflect for insertion between, and engagement with, the two frame elements FIGS. 17 to 23 show various arrangements of a tenth embodiment of the invention. For sake of simplicity the tenth embodiment is described only with respect to the second embodiment of the invention. However, the tenth embodiment of the invention may be used with respect to any of the attachment devices of the first to seventh embodiments of the invention. Also, the corresponding reference numerals shown in the first to seventh embodiment are used to identify the corresponding parts in the tenth embodiment.

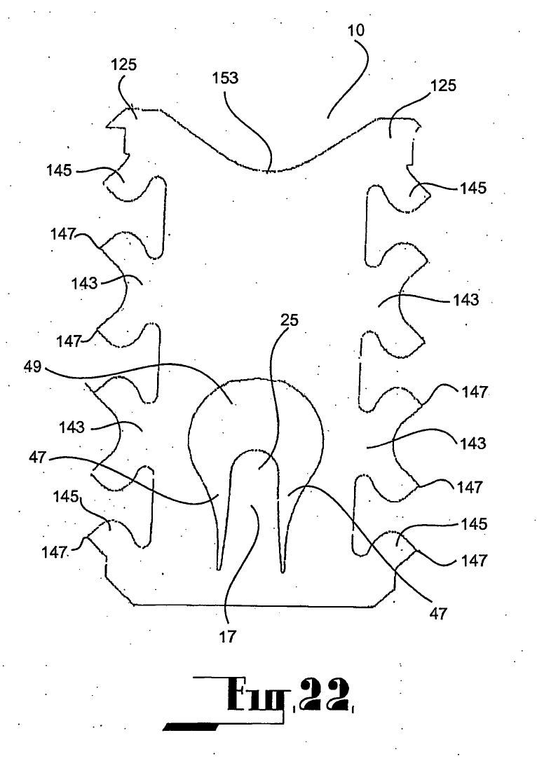

As shown in FIGS. 17 and 20 the attachment device according to the tenth embodiment is adapted for attachment to an internal surface of a pallet 11. The attachment device 110 is particularly suitable for a stringer pallet 11 of the type having stringers 84 in spaced apart relationship and decking boards 115, 117 on the upper sides and under sides of the stringers 84. The spaced relationship between upper and lower deck boards 115,117 provide the frame elements between which attachment device 10 may be secured as shown in FIG. 17 or 20 of the drawings.

Referring now to FIG. 17 of the drawings, there is shown a pallet 11 incorporating an arrangement of the attachment device 110 according to the tenth embodiment of the invention. The attachment device 110 is fastened to the pallet 11 via resilient portions 120 between the upper 115 and lower 117 deck boards of the pallet 11 and adjacent to the inner surface of stringer 84. The resilient portions 120 comprise teeth 121 which extend from each side 119 of the attachment device 110 into the inner surfaces 123 of the upper 115 and lower 117 stringers 84. The attachment device 110 further comprises tabs 125 for securing (in addition to the resilient portions) the attachment device to the pallet 11 when a web (not shown), attached to the attachment device 110 is wrapped around the load (not shown) located on the upper surface 113 of the pallet. The tab 125 extends from the sides 119 of the attachment device 110 at the end portion 127 of the attachment device 110. Tab 125 forms with respect to sides 119 of body 131 an extended portion which reaches, when the attachment is attached to the pallet 11, beyond upper and lower ends 86 and 88 of the stringer 84 of the pallet 11 and contact the side edges 129 of the upper 115 and lower 117 deck boards. Tab 125 hinders the displacement of the attachment device 110 in direction of the force applied to the attachment device 110 by the web (not shown) during wrapping of the load. Moreover, the tabs 125 may be adapted to do not interfere with the lifting or surveillance equipment. Alternative arrangements may include only one tab 125.

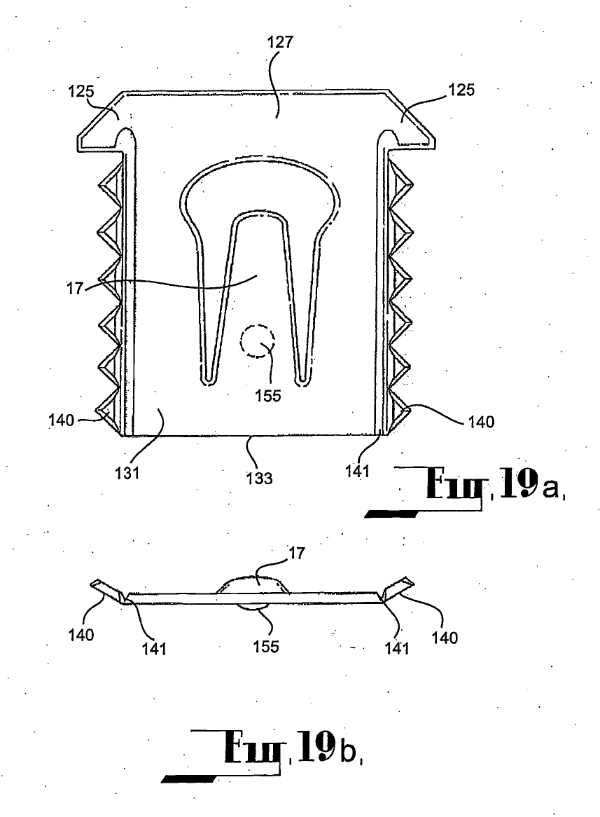

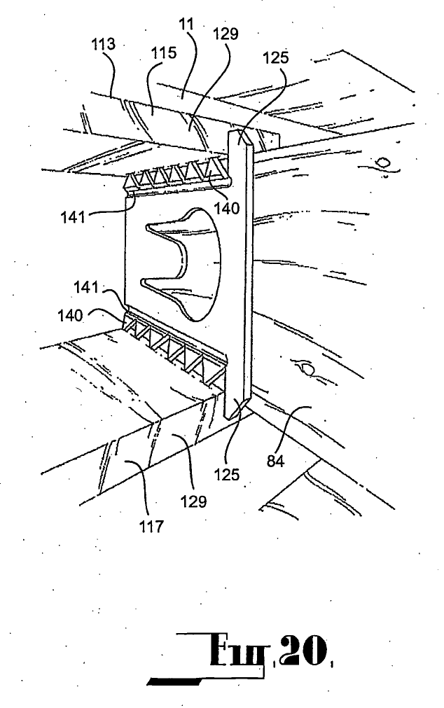

As shown in FIGS. 18a and 18b a first arrangement of the attachment device 110 according to the tenth embodiment of the invention comprises a body 131 to which are attached at its lower front portion 133 resilient portions 135 comprising teeth 137. Resilient portions 135 are attached to the body 131 via unions 139. As shown in FIG. 18b, resilient portions 137 are sandwiched between upper and lower surfaces of the body 131. However, other arrangements are possible wherein the resilient portions are located over or under the upper or lower surface 132 of body 131.

The resilient portions are made out of a material which returns to its original shape after being deformed. Examples of such materials are metals such as stainless steel, among others.

While the arrangement has been described as having two resilient portions 120 on opposed sides of the attachment device, it is of course possible that the necessary resiliency can be achieved by having a resilient portion on only one side of the attachment device.

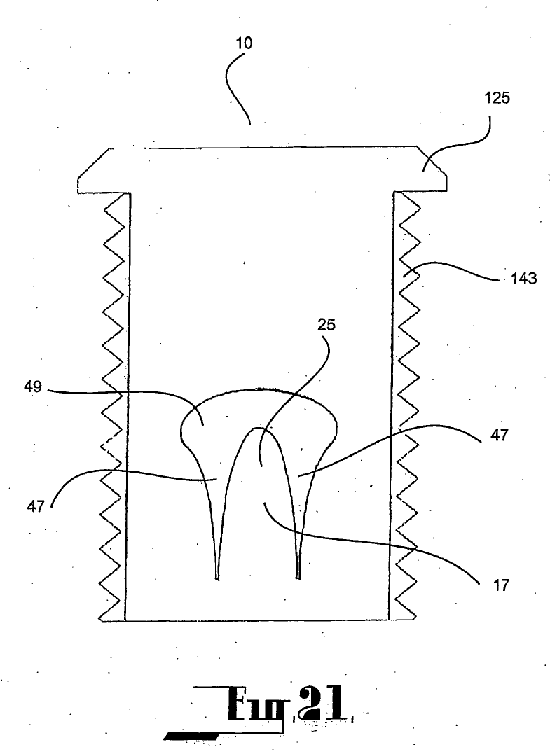

FIGS. 19a and 19b show an arrangement of the tenth embodiment of the invention wherein the resilient portions are an integral part of the body 131 of the attachment device. Side edges of body 131 may be cut to form teeth 140. Additionally, grooves 141 may be formed along the sides of body 113 separating teeth 140 from the body 131. The grooves 141 help teeth 140 to flex when a force is applied to them. The body is made out of a material which returns to its original shape after being deformed. Thus, teeth 140 provide a resilient portion at each side of the body 131. FIG. 20 shows a pallet 11 incorporating the above described second arrangement of the attachment device 110 according to the tenth embodiment of the invention.

The arrangement of the tenth embodiment of the invention shown in FIGS. 18 and 19 comprises a protrusion 155 on the inner side of the tongue 17 to contact the inner face of the stringer 84 (see FIG. 20) and thereby causing the tongue 17 to deflect outwardly. Other arrangements (see FIG. 21) do not include the protrusion 155. These arrangements are suitable to be used with pallets 11 that include cavities 63 onto which the attachment device 10 are located as explained with reference to FIG. 2.

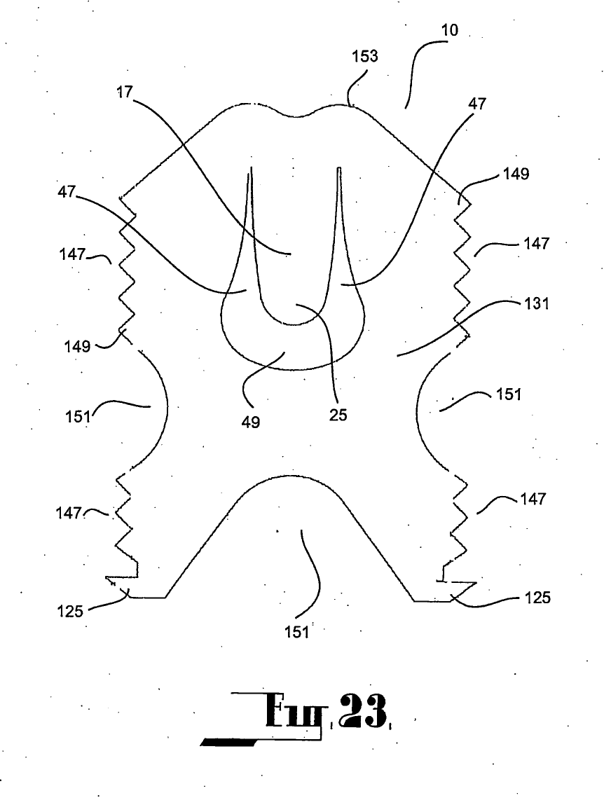

FIG. 22 shows a further arrangement of the tenth embodiment of the invention. As shown, the resilient portion of the attachment device may comprise teeth 143 having one or more tips 147.

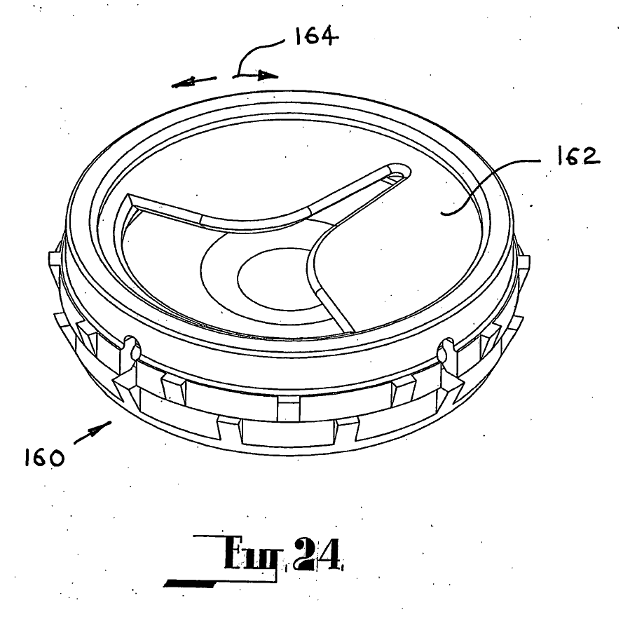

FIG. 23 shows an even further arrangement of the tenth embodiment of the invention. As shown, a plurality of resilient portions 147 comprising teeth 149 is located around the periphery of the body 131 of the attachment device 110. The attachment device 110 according to this arrangement may include indentations. 151 and/or curved edges 153. The use of indentations 151 reduces the amount of material required to manufacture the attachment device as well as permits easy fixation or release of the attachment device to or from the pallet 11. The curved edges 153 avoid injury to operators handling the pallets and goods mounted on the pallets.

FIG. 24 shows, the attachment device 160 wherein the portion receiving and retaining the wrapping film 162 is rotatable 164 to face any direction opposite to or away from the resultant of forces applied by the wrapping film (not shown) under tension thereby further securing and reducing the possibility of dislodgement of the wrapping web from the device.

Referring to FIG. 17, in use, the attachment device 110 is located between the two elements (upper and lower deck boards 115, 117) and put in place adjacent to the stringer 84. The resilient portion (for example, teeth 121, see FIG. 18) are deformed by the force applied to the attachment device 110 when locating the attachment device 110 between the upper and lower deck boards 115, 117. Once the attachment device 110 is in place the resilient portion tries to return to its original shape thus applying a force against the upper and lower deck boards 115, 117. This fixes the attachment device 110 to the pallet 11. This allows for a releasable attachment of the attachment device to a pallet. It permits a fast and easy way for attaching the attachment device to the pallet as well as detachment the attachment device from the pallet, for example, after unwrapping the goods loaded on the pallet or damage and/or disposal of the pallet.

From the forgoing, it is evident that the present invention provides a simple yet highly effective arrangement for attaching an end of a web of wrapping film to a pallet. The invention allows the end of the web of wrapping film to be anchored to the pallet without it being required to be wrapped around part of the pallet and tied as is the case with conventional practice. This is particularly advantageous as it allows the wrapping film to be readily attached and readily removed from the pallet. It also eliminates the need to use a cutting device such as a knife for removal of remnant wrapping film attached to the pallet after unloading thereof. Modifications and improvements can be made without departing from the scope of the invention.

By way of example, the attachment device need not be limited in application to pallets. An attachment device in accordance to the present invention may be used with any appropriate surface. For example, the attachment device may be fixed to trailers to be towed by vehicles or racks fixed to the roofs of vehicles or watercraft.

The attachment device may be fixed (permanently or releasably) to a frame defining the surface. Also, the attachment device may form (partially or completely) part of the frame, as previously explained with reference to the eighth and ninth embodiment of the invention.

Moreover, a plurality of attachment devices in accordance to the invention may be attached and/or form part of a surface onto which goods are to be loaded. Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. An attachment device for attaching a web of wrapping film to a surface, the attachment device comprising a body having at least one wedged bite portion adapted to receive and captively retain the wrapping web.

2. An attachment device according to claim 1 wherein the body comprises a base and a tongue projecting from the base, the tongue and the base defining the at least one wedged bite portion.

3. An attachment device according to claim 2 further comprising at least one protrusion to deflect the tongue from the base for defining the at least one wedged portion.

4. An attachment device according to claim 2 wherein the tongue has two lateral flanks, each defining a wedged bite portion with respective adjacent portions of the base.

5. An attachment device according to claim 2 wherein the tongue is formed separately from the base.

6. An attachment device according to claim 1 wherein the body comprises a split portion defining the bite portion.

7. An attachment device according to claim 6 wherein the split portion has a first end and the split portion tapering inwardly from the first end to a second end; the first end being adapted to receive the web.

8. An attachment device according to claim 7 wherein the second end is closed.

9. An attachment device according to claim 1 wherein the body comprises at least one tongue, the tongue and the surface defining the at least one bite portion.

10. An attachment device according to claim 1 wherein the body is adapted to be attached to the surface.

11. An attachment device according to claim 10 wherein the body comprise mounting holes adapted to receive fasteners.

12. An attachment device according to claim 10 wherein the body is releasably attached to the surface.

13. An attachment device according to claim 12 wherein the body comprise at least one resilient portion adapted to secure the attachment device to the surface.

14. An attachment device according to claim 13 wherein the at least one resilient portion comprises at least one tooth for gripping engagement with the surface.

15. An attachment device according to claim 1 wherein the body is configured to be clampingly retained between two spaced apart frame elements, the arrangement being that body is adapted to be jammed or wedged between the two frame elements.

16. An attachment device according to claim 15 wherein the body is adapted to resiliently deflect for insertion between, and engagement with, the two frame elements.

17. An attachment device according to claim 1 wherein the body is formed integrally with the surface.

18. An attachment device according to claim 1 wherein the body is adapted to provide protection to the wedged bite portion.

19. An attachment device according to claim 1 wherein the body comprises at least one non-cutting contour.

20. An attachment device according to claim 1 wherein the body comprises at least one indentation.

21. An attachment device according to claim 1 wherein the surface is a surface of a pallet.

22. A pallet incorporating at least one attachment device as described in claim 1.

23. A pallet according to claim 22 wherein the at least one attachment device is integrally formed in at least one stringer of the pallet.

24. A pallet according to claim 22 comprising at least one surface adapted to receive at least one attachment device.

25. A pallet according to claim 24 wherein the at least one surface comprises a cavity adapted to receive the attachment device.

26. A pallet according to claim 22 wherein the at least one attachment device is located between a plurality of deck boards of the pallet.

27. A pallet according to claim 22 wherein the at least one attachment device is located at an exterior surface of the pallet.

28. An attachment device for attaching a web of wrapping film according to claim 1 wherein the portion adapted to receive and retain the wrapping film is rotatable in any direction.

29. A pallet according to claim 22 incorporating at least one attachment device, the attachment device for attaching a web of wrapping film to a surface, the attachment device comprising a body having at least one wedged bit portion adapted to receive and captively retain the wrapping web.

30.-31. (canceled)
